(19) United States
(12) Patent Application Publication
(10) Pub. No.: US 2024/0141191 A1
(43) Pub. Date: May 2, 2024

(54) INKJET INK AND INKJET RECORDING METHOD

(71) Applicant: KYOCERA Document Solutions Inc., Osaka (JP)

(72) Inventor: Tsubasa HIDAKA, Osaka (JP)

(73) Assignee: KYOCERA Document Solutions Inc., Osaka (JP)

(21) Appl. No.: 18/493,746

(22) Filed: Oct. 24, 2023

(30) Foreign Application Priority Data
Oct. 28, 2022 (JP) 2022-173785

(51) Int. Cl. C09D 11/322; C09D 11/033; C09D 11/324; D21H 19/42; D21H 19/82

(52) U.S. Cl. CPC C09D 11/322; C09D 11/033; C09D 11/324; D21H 19/42; D21H 19/828

(57) ABSTRACT

An inkjet ink contains a pigment, a water-soluble organic solvent, water, and a surfactant. The water-soluble organic solvent includes a glycol ether compound. A difference between a dynamic surface tension γ₁₀ of the inkjet ink at a surface age of 10 milliseconds and a dynamic surface tension γ₁₀₀₀₀ of the inkjet ink at a surface age of 10000 milliseconds is no greater than 3.4 mN/m. An inkjet recording method is an inkjet recording method for forming an image on a recording medium with the above-mentioned inkjet ink and includes forming the image by ejecting the inkjet ink toward the recording medium. The recording medium is a poorly absorbent recording medium.

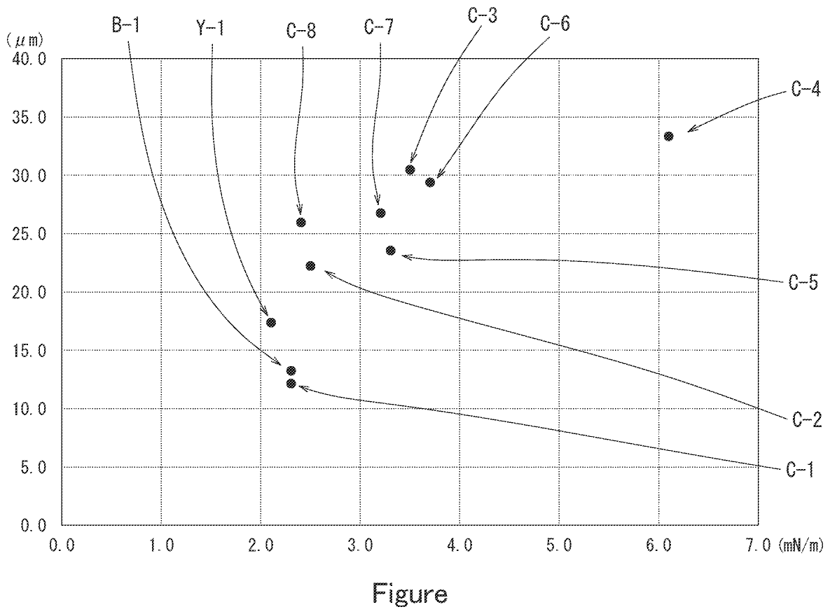

### INCORPORATION BY REFERENCE

The present application claims priority under 35 U.S.C. § 119 to Japanese Patent Application No. 2022-173785, filed Oct. 28, 2022. The contents of this application are incorporated herein by reference in their entirety.

### BACKGROUND

The present disclosure relates to an inkjet ink and an inkjet recording method.

Water-based inkjet inks that contain a pigment and an aqueous medium are used in inkjet recording devices. The inkjet inks are often used to form images on permeable recording media such as copy paper and are also used to form images on poorly absorbent recording media that are difficult to absorb inks, such as coated paper and matte coated paper.

When forming images on the poorly absorbent recording medium with an inkjet ink, images formed on different types of recording media may have different line widths. For example, images formed on coated paper with an inkjet ink tend to have a thinner line width than images formed on matte coated paper.

As an inkjet ink used for image formation on poorly absorbent recording media, an inkjet ink has been proposed that contains, for example, a colorant, an organic solvent, and water. The inkjet ink has a dynamic surface tension and an organic solvent solubility parameter adjusted within respective specific ranges.

### SUMMARY

An inkjet ink according to an aspect of the present disclosure contains a pigment, a water-soluble organic solvent, water, and a surfactant. The water-soluble organic solvent includes a glycol ether compound. In the inkjet ink of the present disclosure, a difference between a dynamic surface tension γ₁₀ at a surface age of 10 milliseconds and a dynamic surface tension γ₁₀₀₀₀ at a surface age of 10,000 milliseconds is no greater than 3.4 mN/m.

An inkjet recording method according to another aspect of the present disclosure is an inkjet recording method for forming an image on a recording medium with the above-mentioned inkjet ink. The inkjet recording method includes forming the image by ejecting the inkjet ink toward the recording medium. The recording medium is a poorly absorbent recording medium.

### BRIEF DESCRIPTION OF THE DRAWINGS

FIGURE is a graph representation showing the relationship between difference Δ and difference in line width for each ink of Examples and Comparative Examples.

### DETAILED DESCRIPTION

Embodiments of the present disclosure are described below. Noted that, in the following, values for dynamic surface tension of an ink are values as measured by the bubble pressure method (maximum bubble pressure method) at 25° C. A specific measurement method is a method described in Examples or a method based thereon.

In the following, unless otherwise specified, measured values for volume median diameter (D₅₀) are values as measured using a dynamic light scattering type particle size distribution analyzer (e.g., “ZETASIZER” (Japanese registered trademark) NANO ZS”, product of Malvern Panalytical Ltd).

In the present specification, the term “(meth)acryl” is used as a generic term for both acryl and methacryl. One type of each component described in the present specification may be used independently, or two or more types of the component may be used in combination. “At least one of A and B” means “either or both A and B”.

### First Embodiment: Inkjet Ink

An inkjet ink (hereinafter referred to as ink) according to a first embodiment of the present disclosure contains a pigment, a water-soluble organic solvent, water, and a surfactant. The water-soluble organic solvent includes a glycol ether compound. In the ink according to the present embodiment, a difference (hereinafter, also refer to as difference Δ) between a dynamic surface tension γ₁₀ at a surface age of 10 milliseconds and a dynamic surface tension γ₁₀₀₀₀ at a surface age of 10000 milliseconds is no greater than 3.4 mN/m.

Examples of a recording medium for image formation with the ink according to the present embodiment include a recording medium made from paper, resin, metal, glass, or ceramics. The recording medium is preferably a poorly absorbent recording medium (especially, coated paper or matte paper) that is difficult to absorb ink (i.e., ink absorbency is poor). The ink according to the present embodiment can form images with consistent line width even when forming an image on a poorly absorbent recording medium where the line width tends to vary based on the types of the poorly absorbent recording media.

The ink according to the present embodiment having the above-mentioned configuration can form images with consistent line width on various recording media (especially, various poorly absorbent recording media). The reasons are inferred as follows. First, a reason why the line width readily fluctuates in image formation on poorly absorbent recording media using a known ink is described. The poorly absorbent recording media are collectively categorized as “poorly absorbent” recording media, but their ink absorbency may vary depending on their types. For example, coated paper has relatively high ink absorbency among the poorly absorbent recording media. Therefore, when forming images on coated paper with a known ink, the known ink that has landed on the surface of the coated paper is absorbed by the coated paper in a relatively short period of time before spreading over the surface of the coated paper, thereby forming images with relatively thin line width. In contrast, matte coated paper has particularly low ink absorbency among the poorly absorbent recording media. Therefore, in image formation on matte coated paper with a known ink, the known ink that has landed on the surface of the matte coated paper remains on the surface of the matte coated paper for a relatively long time before being absorbed. Here, the dynamic surface tension of known inks gradually decreases over time after ejecting due to the large difference Δ described above. Therefore, the known ink that remains on the surface of the matte coated paper is more likely to spread due to the decrement of the dynamic surface tension. Accordingly, the known ink that has landed on the surface of the matte coated paper spreads while remaining on the surface of the matte coated paper, thereby forming images with relatively thick line width. As such, known inks form images with thick line widths on poorly absorbent recording media with particularly low ink absorbency, and form images with thin line width on poorly absorbent recording media with relatively high ink absorbency.

In contrast, with respect to the ink according to the present embodiment, the difference Δ between a dynamic surface tension γ₁₀ at a surface age of 10 milliseconds and a dynamic surface tension γ₁₀₀₀₀ at a surface age of 10000 milliseconds is no greater than 3.4 mN/m, which is relatively small. That is, the dynamic surface tension of the ink according to the present embodiment immediately after being ejected (inkjet ejection) varies little until its surface condition stabilizes.

The following describes a case where an image is formed on matte coated paper with the ink according to the present embodiment. The ink according to the present embodiment that has landed on the surface of the matte coated paper is the same as the known inks in that it takes a relatively long time to be absorbed by the matte coated paper. However, the small difference Δ results in the dynamic surface tension of the ink according to the present embodiment barely decreasing until the ink is absorbed. As such, the ink according to the present embodiment hardly spreads over the surface of the matte coated paper during the ink remaining on the surface of the matte coated paper because the dynamic surface tension is maintained high. As a result, when forming images on the matte coated paper with the ink according to the present embodiment, images with relatively thin line width can be formed. In contrast, when forming images on coated paper with the ink according to the present embodiment, images with thin line width as thin as that formed on coated paper with a known ink can be formed. As such, even when forming images on a recording medium with particularly low ink absorbency, the ink according to the present embodiment with the reduced difference Δ can form images with line widths as thin as that of images formed on a recording medium with relatively high ink absorbency. Moreover, the ink according to the present embodiment includes a glycol ether compound and a surfactant, which facilitates adjustment of the difference Δ within the above-mentioned range. The following describes the ink according to the present embodiment in detail.

With respect to the ink according to the present embodiment, the difference Δ between the dynamic surface tension γ₁₀ at a surface age of 10 milliseconds and the dynamic surface tension γ₁₀₀₀₀ at a surface age of 10000 milliseconds is no greater than 3.4 mN/m, preferably no greater than 3.0 mN/m, and more preferably no greater than 2.5 mN/m. It is considered that the smaller the difference Δ, the better, and the optimal difference Δ is 0.0 mN/m. However, in fact, it is difficult to make the difference Δ extremely small. Therefore, the lower limit of the difference Δ is at least 1.5 mN/m, for example. Noted that the dynamic surface tension of the ink according to the present embodiment tends to decrease with prolonged surface aging. Therefore, in general, the dynamic surface tension γ₁₀ indicates a larger value than the dynamic surface tension γ₁₀₀₀₀.

The dynamic surface tension γ₁₀ of the ink according to the present embodiment at a surface age of 10 milliseconds is preferably at least 36.0 mN/m, more preferably at least 40.0 mN/m, and further preferably at least 40.5 mN/m. By setting the dynamic surface tension γ₁₀ to at least 36.0 mN/m, the difference Δ can be easily adjusted within the above range, and the ejection stability of the ink according to the present embodiment can be improved. The upper limit of the dynamic surface tension γ₁₀ is no greater than 45.0 mN/m, for example.

The dynamic surface tension γ₁₀₀₀₀ of the ink according to the present embodiment at a surface age of 10000 milliseconds is preferably at least 33.0 mN/m, and more preferably at least 38.0 mN/m. By setting the dynamic surface tension γ₁₀₀₀₀ to at least 33.0 mN/m, the difference Δ can be easily adjusted within the above range, and the ejection stability of the ink according to the present embodiment can be improved. The upper limit of the dynamic surface tension γ₁₀₀₀₀ is no greater than 42.0 mN/m, for example.

### (Pigment)

The pigment of the ink according to the present embodiment constitutes pigment particles together with a pigment coating resin, for example. The pigment particles each include, for example, a core containing the pigment and the pigment coating resin covering the core. The pigment coating resin is present in dispersed state in a solvent, for example. From the viewpoints of improving color density, hue, or stability of the ink according to the present embodiment, the pigment particles preferably have a D₅₀ of at least 30 nm and no greater than 200 nm, and more preferably at least 70 nm and no greater than 130 nm.

Examples of the pigment include yellow pigments, orange pigments, red pigments, blue pigments, violet pigments, and black pigments. Examples of the yellow pigments include C.I. Pigment Yellow (74, 93, 95, 109, 110, 120, 128, 138, 139, 151, 154, 155, 173, 180, 185, or 193). Examples of the orange pigment include C.I. Pigment Orange (34, 36, 43, 61, 63, or 71). Examples of the red pigments include C.I. Pigment Red (122 or 202). Examples of the blue pigments include C.I. Pigment Blue (15, specifically, 15:3). Examples of the violet pigments include C.I. Pigment Violet (19, 23, or 33). Examples of the black pigments include C.I. Pigment Black (7).

The pigment has a percentage content in the ink according to the present embodiment of preferably at least 0.5% by mass and no greater than 10.0% by mass, and more preferably at least 1.5% by mass and no greater than 5.0% by mass. As a result of the percentage content of the pigment being set to at least 0.5% by mass, the ink according to the present embodiment can easily form images with desired image density. As a result of the percentage content of the pigment being set to no greater than 10.0% by mass by contrast, fluidity of the pigment in the ink can be increased. As such, the ink according to the present embodiment can easily form images with desired image density.

### (Pigment Coating Resin)

The pigment coating resin is a resin soluble in the ink according to the present embodiment. A portion of the pigment coating resin is present, for example, on the surfaces of the pigment particles to increase pigment particle dispersibility. Another portion of the pigment coating resin is present, for example, in a dissolved state in the ink according to the present embodiment. The pigment coating resin is preferably an acrylic resin. The acrylic resin is a polymer of at least one monomer of (meth)acrylic acid alkyl ester and (meth)acrylic acid.

The pigment coating resin has a percentage content in the ink according to the present embodiment of preferably at least 0.1% by mass and no greater than 5.0% by mass, and more preferably at least 0.5% by mass and no greater than 2.0% by mass.

### (Water-soluble Organic Solvent)

The water-soluble organic solvent functions as a solvent or dispersion medium in the ink according to the present embodiment together with water. The water-soluble organic solvent includes a glycol ether compound.

### (Glycol Ether Compound)

The glycol ether compound improves permeability of the ink according to the present embodiment to the recording media and imparts appropriate dynamic surface tension to the ink.

The glycol ether compound is a compound in which a hydroxyl group (—OH group) at one or both ends of an alkylene glycol compound is substituted with a lower alkyl group. Examples of the glycol ether compound include ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, dipropylene glycol monomethyl ether, dipropylene glycol monoethyl ether, triethylene glycol monomethyl ether, triethylene glycol monobutyl ether, and tripropylene glycol monomethyl ether.

The glycol ether compound is preferably triethylene glycol monobutyl ether.

The glycol ether compound has a percentage content in the ink according to the present embodiment of preferably at least 3.0% by mass and no greater than 25.0% by mass, and more preferably at least 6.0% by mass and no greater than 18.0% by mass. The water-soluble organic solvent may further include other water-soluble organic solvents other than the glycol ether compound. Examples of other glycol ether compound include glycol compounds, lactam compounds, nitrogen-containing compounds, acetate compounds, thiodiglycol, glycerin, and dimethyl sulfoxide.

Examples of the glycol compounds include ethylene glycol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, and tetraethylene glycol.

Examples of the lactam compounds include 2-pyrrolidone and N-methyl-2-pyrrolidone.

Examples of the nitrogen-containing compounds include 1,3-dimethylimidazolidinone, formamide, and dimethyl formamide.

Examples of the acetate compounds include diethylene glycol monoethyl ether acetate.

The other water-soluble organic solvent is preferably a glycol compound or a glycol ether compound, and more preferably propylene glycol or 2-pyrrolidone.

The other water-soluble organic solvent has a percentage content in the ink according to the present embodiment of preferably at least 15.0% by mass and no greater than 60.0% by mass, and more preferably at least 35.0% by mass and no greater than 45.0% by mass.

The glycol compound has a percentage content in the ink of the present embodiment of preferably at least 15.0% by mass and no greater than 55.0% by mass, and more preferably at least 35.0% by mass and no greater than 45.0% by mass.

The lactam compound has a percentage content in the ink according to the present embodiment of preferably at least 0.3% by mass and no greater than 5.0% by mass, and more preferably at least 1.0% by mass and no greater than 2.0% by mass.

### (Water)

The water has a percentage content in the ink according to the present embodiment of preferably at least 20.0% by mass and no greater than 60.0% by mass, and more preferably at least 30.0% by mass and no greater than 50.0% by mass.

### (Surfactant)

The surfactant improves wettability of the ink according to the present embodiment to a recording medium and compatibility of each component contained in the ink according to the present embodiment. The surfactant is preferably a nonionic surfactant. Moreover, the surfactant imparts appropriate dynamic surface tension to the ink according to the present embodiment.

Examples of the nonionic surfactant include silicone surfactants, acetylene diols, and ethylene oxide adducts of acetylene diols. Examples of the acetylene diols include 2,4,7,9-tetramethyl-5-decyne-4, 7-diol, 3,6-dimethyl-4-octyne-3,6-diol, 3,5-dimethyl-1-hexyne-3-ol, and 2,4-dimethyl-5-hexyne-3-ol.

The surfactant has a percentage content in the ink according to the present embodiment of preferably at least 0.1% by mass and no greater than 3.0% by mass, and more preferably at least 0.3% by mass and no greater than 1.2% by mass.

### (Other Components)

The ink according to the present embodiment may further contain any known additive (specific examples include an anti-drying agent, an antioxidant, a viscosity modifier, a pH adjuster, an antifungal agent, and a moisturizer) as necessary.

The ink according to the present embodiment preferably has any of Compositions (1) to (4) indicated below in Table 1 as its composition. Noted that, in Table 1 below, the percentage content of each component is indicated in a numerical range. For example, “3.0-5.0” being the percentage content of the pigment in Composition 1 indicates that the percentage content of the pigment is preferably at least 3.0% by mass and no greater than 5.0% by mass. The same applies to the percentage contents of other components.

TABLE 1

| Composition | | 1 | 2 | 3 | 4 |
|---|---|---|---|---|---|
| Percent by mass | Pigment | 3.0-5.0 | 3.0-5.0 | 3.0-5.0 | 3.0-5.0 |
| | Pigment coating resin | 0.7-1.4 | 0.7-1.4 | 0.7-1.4 | 0.7-1.4 |
| | Triethylene glycol | 6.0-10.0 | 6.0-10.0 | 14.0-18.0 | 14.0-18.0 |
| | monobutyl ether | | | | |
| | Propylene glycol | 38.0-42.0 | 37.0-41.0 | 29.0-33.0 | 29.0-33.0 |
| | 2-Pyrrolidone | 1.0-2.0 | 1.0-2.0 | 1.0-2.0 | 1.0-2.0 |
| | Surfactant | 0.3-0.7 | 0.8-1.2 | 0.8-1.2 | 0.3-0.7 |

| | |
|---|---|
| Water | Rest |

### Ink Production Method

A production method of the ink according to the present embodiment is not particularly limited as long as the pigment and the other components added as necessary can be mixed uniformly. A specific example of the production method of the ink according to the present embodiment is a method of stirring each component of the ink according to the present embodiment using a stirrer to mix uniformly and removing foreign substances and coarse particles using a filter (for example, a filter with a pore size of no greater than 5 μm).

Where water is added in the production method of the ink according to the present embodiment, the water is preferably ion exchange water.

### Second Embodiment: Inkjet Recording Method

An inkjet recording method according to a second embodiment of the present disclosure is an inkjet recording method for forming an image on a recording medium with the ink according to the first embodiment. The inkjet recording method includes forming an image (image formation) by ejecting (ink ejection) the ink according to the first embodiment toward a recording medium. The recording medium is a poorly absorbent recording medium. By the inkjet recording method according to the second embodiment of the present disclosure, which uses the ink according to the first embodiment, an image with consistent line width can be formed on various recording media. The poorly absorbent recording medium is preferably coated paper or matte coated paper. The ink ejection in the image formation can be performed using a known inkjet recording apparatus equipped with a recording head, for example. Examples of the recording head include piezoelectric inkjet heads and thermal inkjet heads.

### EXAMPLES

The following describes examples of the present disclosure. However, the present disclosure is not limited to the following examples.

### Pigment Dispersions Preparation

### (Preparation of Cyan Pigment Dispersion)

A mixed liquid was obtained by mixing 15 parts by mass of a cyan pigment (“HELIOGEN (registered Japanese trademark) BLUE D 7088”, product of BASF Japan Co., Ltd, C.I. Pigment Blue 15:3), 10 parts by mass of a pigment coating resin-containing dispersion (“DISPERBYK (registered Japanese trademark) 190”, product of BYK Japan KK, non-volatile content: 40%, active component: acrylic resin), and 75 parts by mass of water followed by pre-dispersion using a disperser. Next, the above mixed liquid was subjected to a dispersion treatment using a bead mill (“DYNO MILL”, product of Willy A. Bachofen AG) with a capacity of 0.6 L charged with 1800 g of zirconia beads with a diameter of 0.1 mm as a dispersion medium. As a result, a cyan pigment dispersion (C) (pigment concentration: 15% by mass) was obtained.

### (Preparation of Yellow Pigment Dispersion)

A yellow pigment dispersion (Y) (pigment concentration: 15% by mass) was obtained according to the same method as that for preparing the cyan pigment dispersion (C) in all aspects other than that a yellow pigment (“FAST YELLOW 7413”, product of SANYO COLOR WORKS, Ltd., C.I. Pigment Yellow 74) was used instead of the cyan pigment.

### (Preparation of Black Pigment Dispersion)

A black pigment dispersion (B) (pigment concentration: 15% by mass) was obtained according to the same method as that for preparing the cyan pigment dispersion (C) in all aspects other than that a black pigment (“PRINTEX (registered Japanese trademark) 85”, product of ORION ENGINEERED CARBONS KK″, carbon black) was used instead of the cyan pigment.

### Ink Preparation

Components with the types and percentage contents shown in Table 2 below were added to a container. The container contents were mixed uniformly by stirring at a rotation speed of 400 rpm using a stirrer (“THREE-ONE MOTOR BL-600”, product of Shinto Scientific Co., Ltd.). The resultant mixed liquid was filtered using a filter with a pore size of 5 μm to remove foreign substances and coarse particles. As a result, cyan inks (C-1) to (C-8), yellow ink (Y-1), and black ink (B-1) were obtained.

Cyan ink (C-1), (C-2), (C-5), (C-7), and (C-8), yellow ink (Y-1), and black ink (B-1) were used as inks of Examples 1 to 7, respectively. Cyan inks (C-3), (C-4) and (C-6) were used as inks of Comparative Examples 1 to 3, respectively.

Details of each component in Table 2 are as shown below.
BT: triethylene glycol monobutyl ether (product of NIPPON NYUKAZAI CO., LTD.)
PG: propylene glycol (product of DuPont Specialty Products Co., Ltd.)
2-Pyrrolidone: product of Mitsubishi Chemical Corporation
Surfactant (S-1): nonionic surfactant (“OLFINE (registered Japanese trademark) E1010”, product of Nissin Chemical Industry Co., Ltd, content: ethylene oxide adduct of acetylene diol, active component concentration: 100% by mass, HLB value: 13.5±0.5)
Surfactant (S-2): nonionic surfactant (“SURFYNOL (registered Japanese trademark) 440”, product of Nissin Chemical Industry Co., Ltd, content: ethylene oxide adduct of acetylene glycol, active component concentration: 100% by mass, HLB value: 8)
Surfactant(S-3): surfactant (“APX4221-E”, proudct of kyoeisha Chemical Co., Ltd.)
Surfactant (S-4): nonionic surfactant (“OLFINE (registered Japanese trademark) EXP4300”, product of Nissin Chemical Industry Co., Ltd., acetylene surfactant, active component concentration: 60% by mass, solvent: propylene glycol and dipropylene glycol.

TABLE 2

| Ink | | | C-1 | C-2 | C-3 | C-4 | C-5 | C-6 | C-7 | C-8 | Y-1 | B-1 |
|---|---|---|---|---|---|---|---|---|---|---|---|---|
| Percent | Pigment | C | 26.7 | 26.7 | 33.3 | 26.7 | 26.7 | 26.7 | 26.7 | 26.7 | — | — |
| by | dispersion | Y | — | — | — | — | — | — | — | — | 26.7 | — |
| mass | | B | — | — | — | — | — | — | — | — | — | 26.7 |
| | BT | | 8.0 | 8.0 | 4.0 | 16.0 | 16.0 | 16.0 | 16.0 | 16.0 | 8.0 | 8.0 |
| | PG | | 39.7 | 39.2 | 39.2 | 31.2 | 31.2 | 31.2 | 31.2 | 31.2 | 39.7 | 39.7 |
| | 2-Pyrrolidone | | 1.5 | 1.5 | 1.5 | 1.5 | 1.5 | 1.5 | 1.5 | 1.5 | 1.5 | 1.5 |
| | Surfactant | S-1 | 0.5 | — | 0.8 | — | 1.0 | — | — | — | 0.5 | 0.5 |
| | | S-2 | — | 1.0 | 0.4 | — | — | 1.0 | — | 0.5 | — | — |
| | | S-3 | — | — | 1.5 | 1.0 | — | — | — | — | — | — |
| | | S-4 | — | — | — | — | — | — | 1.0 | — | — | — |

| | |
|---|---|
| Ion exchange | Rest |
| water | |
| Total | 100.0 |

### Measurement of Dynamic Surface Tension

With respect to each of the inks, the dynamic surface tension γ₁₀ at a surface age of 10 millisecond and the dynamic surface tension γ₁₀₀₀₀ at a surface age of 10000 milliseconds were measured by the maximum bubble pressure method using a dynamic surface tension measuring device (“BP-100”, product of KRUSS Scientific). The measurement temperature was 25° C. The measurement results are shown in Table 3 below.

### Evaluation

With respect to each of the inks of Examples 1 to 7 and Comparative Examples 1 to 3, differences in line width between images formed on coated paper and images formed on matte coated paper were evaluated by the following method. Noted that, unless otherwise specified, evaluations were conducted in an environment with a temperature of 25° C. and a relative humidity of 60%. The evaluation results are shown in Table 3 below.

### Evaluation Apparatus

As an inkjet recording device for evaluation, an inkjet recording apparatus (prototype evaluation apparatus produced by KYOCERA Document Solutions Japan Inc.) equipped with a line-type recording head was prepared. The amount of ink ejected from the line-type recording head was set to 2 pL. The line-type recording head accommodated any of the inks of Examples 1 to 7 and Comparative Examples 1 to 3 to be evaluated.

Coated paper (“OK TopKote+”, product of Oji Paper Co., Ltd.) and matte coated paper (“SILVER DIA (registered Japanese trademark) S”, product of Nippon Paper Industries Co., Ltd.) were used as the recording media.

### Line Width Difference

A thin line image was formed on each of two types of recording media (the coated paper and the matte coated paper) using the evaluation apparatus. When forming the thin line image, the line width of a horizontal line was set to be formed with one dot. That is, the thin line formed was a one-dot line. Next, the two types of recording media were thoroughly air-dried. Then, the line widths of the thin lines on the two types of recording media were measured. The line width of each thin line was measured at 10 locations and the average value thereof was calculated. Next, the difference between the line width of the thin line formed on the coated paper and the line width of the thin line formed on the matte coated paper was calculated, and the calculated value was taken as an evaluation value for line width difference. Line width difference was evaluated according to the following criteria.

### (Criteria for Line Width Difference)

Good (A): Evaluation value was no greater than 28.0 μm
Poor (B): Evaluation value was greater than 28.0 μm

TABLE 3

| | | | | | Evaluation | | | |
|---|---|---|---|---|---|---|---|---|
| | | | | | | Matte | | |
| | | Dynamic surface tension | | | Coated | coated | Line width | |
| | | γ₁₀ | γ₁₀₀₀₀ | Difference Δ | paper | paper | difference | |
| | Ink | [mN/m] | [mN/m] | [mN/m] | [μm] | [μm] | [μm] | Rate |
| Example 1 | C-1 | 40.8 | 38.5 | 2.3 | 49.2 | 61.4 | 12.2 | A |
| Example 2 | C-2 | 36.7 | 34.2 | 2.5 | 54.2 | 76.6 | 22.4 | A |
| Comparative | C-3 | 34.3 | 30.8 | 3.5 | 54.0 | 84.5 | 30.5 | B |
| Example 1 | | | | | | | | |
| Comparative | C-4 | 39.2 | 33.1 | 6.1 | 51.6 | 85.0 | 33.4 | B |
| Example 2 | | | | | | | | |
| Example 3 | C-5 | 40.4 | 37.1 | 3.3 | 52.1 | 75.8 | 23.7 | A |
| Comparative | C-6 | 37.8 | 34.1 | 3.7 | 54.8 | 84.2 | 29.4 | B |
| Example 3 | | | | | | | | |
| Example 4 | C-7 | 36.8 | 33.6 | 3.2 | 53.0 | 79.7 | 26.7 | A |
| Example 5 | C-8 | 38.0 | 35.6 | 2.4 | 52.4 | 78.4 | 26.0 | A |
| Example 6 | Y-1 | 41.2 | 39.1 | 2.1 | 59.0 | 76.4 | 17.4 | A |
| Example 7 | B-1 | 40.8 | 38.5 | 2.3 | 50.8 | 64.2 | 13.3 | A |

As shown in Tables 2 and 3, the inks of Examples 1 to 7 each contained a pigment, a water-soluble organic solvent, water, and a surfactant. The water-soluble organic solvent included a glycol ether compound. In the inks of Examples 1 to 7, the difference Δ between the dynamic surface tension γ₁₀ at a surface age of 10 milliseconds and the dynamic surface tension γ₁₀₀₀₀ at a surface age of 10000 milliseconds was no greater than 3.4 mN/m. The inks of Examples 1 to 7 formed images with consistent line width on various recording media (the coated paper or the matte coated paper).

In contrast, with respect to each of the inks of Comparative Examples 1 to 3, the above-mentioned difference Δ was greater than 3.4 mN/m. As a result, when forming images with any of the inks of Comparative Examples 1 to 3, there was a large difference in line width between the images formed on the coated paper and the images formed on the matte coated paper.

For reference FIGURE is presented that is a graph representation showing the relationship between the above-mentioned difference Δ and line width difference of each of the inks. In FIGURE, the horizontal axis indicates the difference Δ, and the vertical axis indicates the line width difference. As shown in FIGURE, it is confirmed that the smaller the above-mentioned difference Δ is, the smaller the difference between the line width of the image formed on the coated paper and the line width of the image formed on the matte coated paper is.

What is claimed is:

1. An inkjet ink comprising:
a pigment;
a water-soluble organic solvent;
water; and
a surfactant, wherein
the water-soluble organic solvent includes a glycol ether compound, and
a difference between a dynamic surface tension γ₁₀ of the inkjet ink at a surface age of 10 milliseconds and a dynamic surface tension γ₁₀₀₀₀ of the inkjet ink at a surface age of 10000 milliseconds is no greater than 3.4 mN/m.

2. The inkjet ink according to claim 1, wherein
the dynamic surface tension γ₁₀₀₀₀ at a surface age of 10000 milliseconds of the inkjet ink is at least 38.0 mN/m.

3. The inkjet ink according to claim 1, wherein
the dynamic surface tension γ₁₀ at a surface age of 10 milliseconds of the inkjet ink is at least 40.0 mN/m.

4. The inkjet ink according to claim 1, wherein
the glycol ether compound includes triethylene glycol monobutyl ether.

5. The inkjet ink according to claim 1, wherein
a percentage content of the glycol ether compound is at least 6.0% parts by mass and no greater than 18.0% parts by mass.

6. The inkjet ink according to claim 1, wherein
a percentage content of the surfactant is at least 0.3% parts by mass and no greater than 1.2% parts by mass.

7. The inkjet ink according to claim 1, wherein
the inkjet ink is used for image formation on a poorly absorbent recording medium.

8. The inkjet ink according to claim 1, wherein
the water-soluble organic solvent further includes a glycol compound, and
a percentage content of the glycol compound is at least 35.0% parts by mass and no greater than 45.0% parts by mass.

9. An inkjet recording method for forming an image on a recording medium with the inkjet ink according to claim 1, comprising:
forming the image by ejecting the inkjet ink toward the recording medium, wherein
the recording medium is a poorly absorbent recording medium.

10. The inkjet recording method according to claim 9, wherein
the poorly absorbent recording medium is a coated paper or a matte coated paper.
